(19) United States
(12) Patent Application Publication
(10) Pub. No.: US 2009/0272247 A1
(43) Pub. Date: Nov. 5, 2009

(54) Mechanical string tuner

(76) Inventor: Stefan Zelinka, Sarasota, FL (US)

Correspondence Address: STEFAN ZELINKA, 3233 BENEVA RD, APT 203, SARASOTA, FL, 34232, US

(21) Appl. No.: 12/080,836

(22) Filed: Apr. 7, 2008

(30) Foreign Application Priority Data
Dec. 18, 1997 (SK) 1657-93

(51) Int. Cl. G10D 3/14

(52) U.S. Cl. 84/312 R; 84/455

(57) ABSTRACT

A mechanical metal instrument that can be attached to every electronic and acoustic guitar with the purpose of fast and reliable tuning of the strings to various variations/combinations.

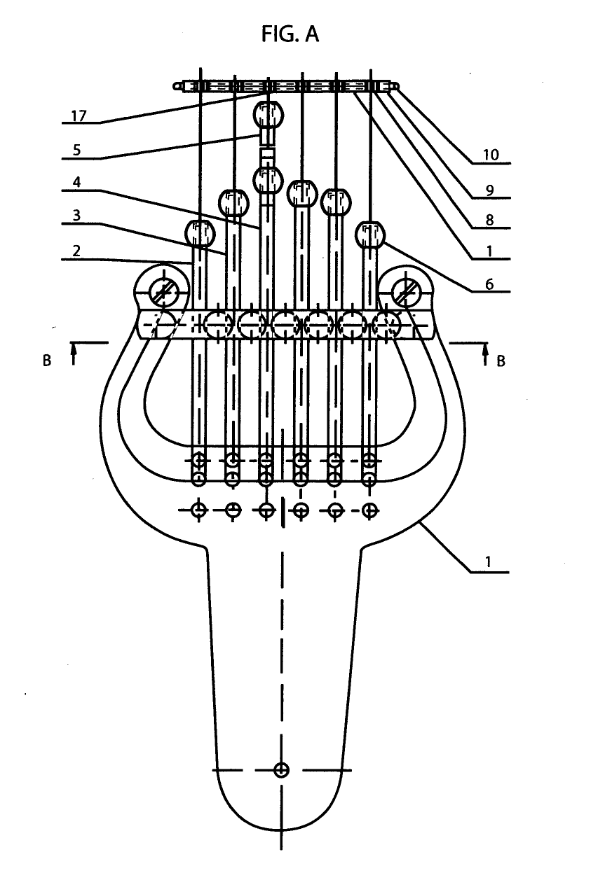

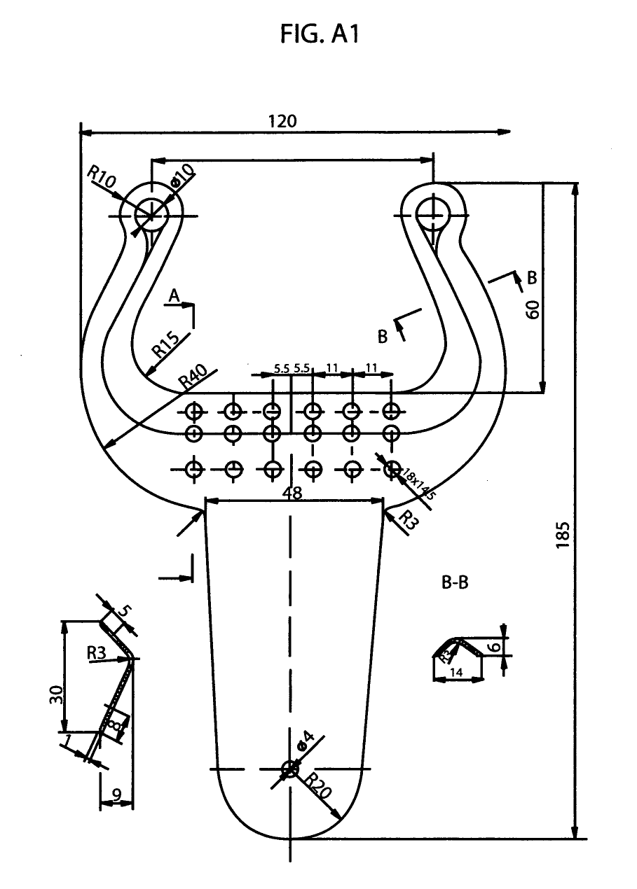

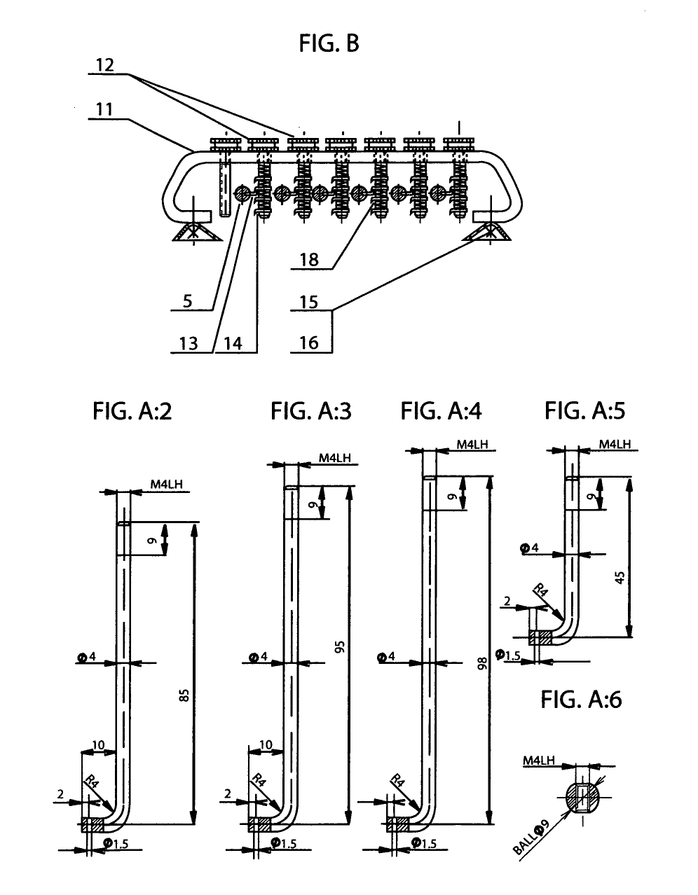

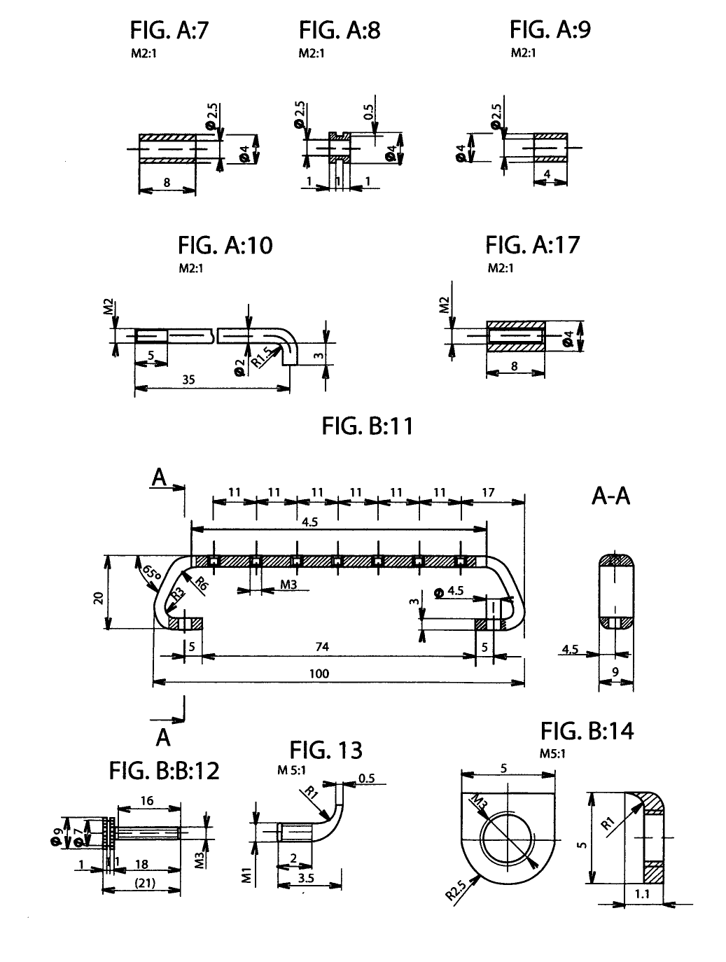

### DESCRIPTION OF DRAWINGS

Figure A

Head-on view of the “Mechanical String Tuner.”

1. Tail piece.

2. Lever for the 6^{th} string.

3. Lever for the 5^{th} string.

4. Lever for the 4^{th} string.

5. Prolonged lever for tuning during play.

6. Lever for the 1^{st} string.

7. Bridge.

8. Roller.

9. Nut.

10. Rod.

17. Inter-barrel

Figure A1

Head-on view of the “Mechanical String Tuner,” sans levers and bridge.

Measurements in millimeters.

Figure B

Side view of item A-A (item name here) from Figure A.

2. Lever for the 6^{th} string

11. Bridge within the tail piece.

12. Screw.

13. Squared nut with nylon insert.

14. Springs.

15. Screw for the tail piece.

16. Screw for the tail piece.

Figure A:2

Item #2 from figure A (lever for the 6^{th} string). Measurements in millimeters.

Figure A:3

Item #3 from figure A (lever for the 5^{th} string). Measurements in millimeters.

Figure A:4

Item #4 from figure A (lever for the 4^{th} string). Measurements in millimeters.

Figure A:5

Item #5 from figure A (prolonged lever for tuning during play). Measurements in millimeters.

Figure A:6

Item #6 from figure A (lever for the 1^{st} string). Measurements in millimeters.

Figure A:7

Item #7 from figure A (bridge). Measurements in millimeters.

Figure A:8

Item #8 from figure A (roller). Measurements in millimeters.

Figure A:9

Item #9 from figure A (nut). Measurements in millimeters.

Figure A:10

Item #10 from figure A (rod). Measurements in millimeters.

Figure B:11

Item 11 from figure B (bridge within the tail piece). Measurements in millimeters.

Figure B:12

Item #12 from figure B (screw). Measurements in millimeters.

Figure B:13

Item #13 from figure B (squared nut with nylon insert). Measurements in millimeters.

Figure B:14

Item #14 from figure B (springs). Measurements in millimeters.

I claim:

1. A tailpiece in the shape of a lyre (Figure A) that attaches to a guitar with one screw and contains six levers, one for each string, with hooks onto which a string is hanged. At the end of the body of the tailpiece there are openings for the bridge, which contains special screws. Each screw (Figure A:12) has a special nut (Figure A:14) on which levers create half tones. The pressing of the levers tunes the strings four half tones higher or lower (up or down).

2. A guitar that has six strings could be tuned to five different open tunings with the aforementioned tailpiece, and those are:
a) First position: guitar tuning: E, H, G, D, A, E
b) Second position: D, H, G, D, H, G
c) Third position: E, H, G(is), E, H, G
d) Fourth position: E, C(is), A, E, A, E
e) Fifth position: E, C, G, E, C, G
Each one of these positions has additional combinations for open tuning 6, 7, may, and 9.

3. The change from position one to two with the loosening of the lever by two halftones lower tunes the string from E to D. When the fifth lever on the fifth string is pressed it heightens the tone of the string from A to H by one tone. When the lever on the sixth string is pressed it heightens the tone from E by one and a half tones to G. Thus, an open tuning is created and G is produced. In other combinations various open tunings are created: such as E6, E7, then, G6, G7, then A6, A7, then C6, C7, etc. The basis of this system is that it is possible to tune your guitar during a performance. All that is required is to set the necessary lever with the prolonged lever for tuning during play (Figure A:5) that strains or loosens the string in half tones, which create the G6 and G7 accord. For example, G6, G7, A6, A7, C6, C7.
